(19) United States
(12) Patent Application Publication
(10) Pub. No.: US 2023/0394081 A1
(43) Pub. Date: Dec. 7, 2023

(54) VIDEO CLASSIFICATION AND SEARCH SYSTEM TO SUPPORT CUSTOMIZABLE VIDEO HIGHLIGHTS

(71) Applicant: Apple Inc., Cupertino, CA (US)

(72) Inventors: Shujie LIU, San Jose, CA (US); Xiaosong ZHOU, Campbell, CA (US); Hsi-Jung WU, San Jose, CA (US); Jiefu ZHAI, Sunnyvale, CA (US); Ke ZHANG, Mountain View, CA (US); Ming CHEN, Mountain View, CA (US)

(21) Appl. No.: 18/327,125

(22) Filed: Jun. 1, 2023

Related U.S. Application Data
(60) Provisional application No. 63/347,784, filed on Jun. 1, 2022.

(51) Int. Cl. G06F 16/783; G06T 7/62; G06F 16/75

(52) U.S. Cl. CPC G06F 16/7837; G06T 7/62; G06F 16/75

(57) ABSTRACT

A video classification, indexing, and retrieval system is disclosed that classifies and retrieves video along multiple indexing dimensions. A search system may field queries identifying desired parameters of video, search an indexed database for videos that match the query parameters, and create clips extracted from responsive videos that are provided in response. In this manner, different queries may cause different clips to be created from a single video, each clip tailored to the parameters of the query that is received.

### CLAIM FOR PRIORITY

The present disclosure benefits from priority of U.S. application Ser. No. 63/347,784, filed Jun. 1, 2022 and entitled “Video Classification and Search System to Support Customizable Video Highlights,” the disclosure of which is incorporated herein in its entirety.

### BACKGROUND

The present disclosure relates to a video classification and search system to support customizable video highlights.

The proliferation of media data captured by audio-visual devices in daily life has become immense, which leads to significant problems in the management and review of such data. Individuals often capture so many videos in their daily lives that it can become too burdensome to edit those videos so that later review is meaningful. And, while some devices attempt to classify videos at a coarse level, prior techniques typically assign quality scores monolithically to videos. For example, a video may be classified as “good” without further granularity. If a video that contains content reflecting several potentially desirable content elements (e.g., video that contains content representing several family members and a pet), designating a video as “good” may not be appropriate for all possible uses.

### BRIEF DESCRIPTION OF THE DRAWINGS

FIG. 1 is a functional block diagram of a system according to an embodiment of the present disclosure.

FIG. 2 illustrates an exemplary video to which principles of the present disclosure may be applied.

FIG. 3 illustrates a method according to an embodiment of the present disclosure.

FIG. 4 is a block diagram of a device according to an aspect of the present disclosure.

### DETAILED DESCRIPTION

Embodiments of the present disclosure overcome disadvantages of the prior art by providing a video classification, indexing, and retrieval system that classifies and retrieves video along multiple indexing dimensions. A search system may field queries identifying desired parameters of video, search an indexed database for videos that match the query parameters, and create clips extracted from responsive videos that are provided in response. In this manner, different queries may cause different clips to be created from a single video, each clip tailored to the parameters of the query that is received.

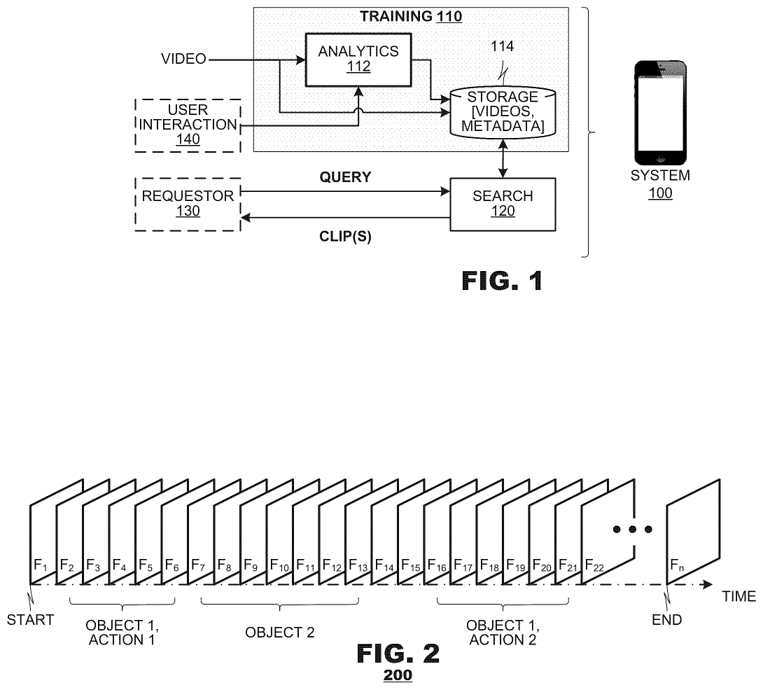

FIG. 1 is a functional block diagram of a system 100 according to an embodiment of the present disclosure. The system may include a training sub-system 110 and a search sub-system 120. The training sub-system 110 may be engaged when new videos are presented to the system for indexing. The search sub-system 120 may be engaged when the system 100 executes queries for indexed videos.

The training system 110 may include an analytics unit 112 and storage 114. When new videos are presented to the system 100, the analytics unit 112 may analyze and/or classify the video according to predetermined classifications. For example, the analytics unit may analyze video for purposes of:
identifying people within video content and, when they are detected, temporal range(s) within the video in which they are detected and (optionally) the sizes of the detected people in the video;
identifying animal(s) within video content and, when they are identified, temporal range(s) within the video in which the animals are detected and (optionally) the sizes of the detected animals in the video;
identifying actions performed by the people and/or animals detected within video and, when they are identified, temporal range(s) within the video in which the actions are detected, action types, and/or the magnitudes of those action(s);
identifying object(s) within video content and, when they are identified, temporal range(s) within the video in which the objects are detected, object motion, and/or magnitude thereof;
performing scene classification of video content and, when they are detected, temporal range(s) within the video in which scenes are detected;
performing motion flow analyses of video content such as by detecting motion flow in the different temporal ranges of the video;
analyzing video content for camera stability in the different temporal ranges of the video;
detecting speakers within video and, when they are detected, temporal range(s) within the video in which speakers are detected; and/or
performing audio analyses of video content to detect speech within video and, when speech is detected, develop textual representations of the detected speed and the temporal range(s) within the video in which speech is detected.
   Queries to the system 100 may include parameters identifying any of the foregoing properties of the videos, which may be used as a basis for searching for stored videos.

The analytics unit 112 may generate metadata to be stored 114 with the video identifying, with respect to a temporal axis of the video, the results of the different analyses. The metadata may be represented as text, scores, or feature vectors that form a basis of search. In an embodiment, machine learning algorithms may be applied to perform the respective detections and classifications. Machine learning algorithms often generate results that have fuzzy outcomes; in such cases, the detections and classification metadata may include score values representing degrees of confidence respectively for the detections and classifications so made.

Stored video metadata also may include playback properties of the video, including, for example, the video's duration, playback window size, orientation (e.g., whether it is in portrait or landscape mode), the playback speed, camera motion during video capture, and (if provided) an indicator whether the video is looped. These playback properties may be provided with the video as it is imported into the system 100 or, alternatively, may be developed by the analytics unit 112.

Stored video metadata also may include metadata developed via user interaction 140 with stored video. For example, users may assign “likes” or other ratings to stored video. Users may edit stored videos or export them to applications (not shown) within the system 100, which may indicate that a user prefers the videos interacted with to other stored videos with which the user has not yet interacted. Users may build new media assets from stored videos by integrating them with other media assets (e.g., combining recorded video with a music asset), in which case classification information relating to the other media asset(s) (the music) may be associated with the stored video. And, of course, users may tag video with identifiers of people, pets, and other objects through direct interaction 140. In an embodiment, the analytics unit 112 may generate user importance scores from such user interaction 140.

As a result of the output of the analytics unit 112, the playback properties, and/or the user interaction, stored video may have a multidimensional array of classification metadata stored therewith. The metadata may be integrated into a search index and thereby provide the basis for searches by the search system 120.

The search system 120 may receive a query from an external requestor 130, perform a search among the videos in storage 114, and return a response that provides responsive videos. Search queries may contain parameter(s) that identify characteristics of desired videos. In one embodiment, the search system 120 may provide clips extracted from responsive videos that are responsive to query parameters, which may cause different clips from a single video to be served in response to different queries.

The system 100 may receive queries from other elements of an integrated computer system (not shown). In one embodiment, the system 100 may be provided as a service within an operating system of a computer device and it may field queries from other elements of the operating system. In another embodiment, the system 100 may field queries from an application that executes on a computer device. In yet a further application, the system 100 may be disposed on a first computer system (for example, a media server) and it may field queries from a separate computer system (a media client) over a communication network (not shown).

FIG. 2 illustrates an exemplary video 200 to which the principles of the present disclosure may be applied. As is typical, the video 200 may include a number of frames F1-Fn arranged along a playback timeline from a start time to an end time.

The example of FIG. 2 illustrates classifications that might be assigned to a video 200. In this example, two objects Object 1 and Object 2 have been identified by the analytics unit 112 (FIG. 1). Object 1 is identified in two separate ranges, corresponding to frames F₃-F₆ and F₁₇-F₂₁, respectively. Object 2 identified in a single range, corresponding to frames F₈-F₁₃.

The example of FIG. 2 also identifies two exemplary action classifications that are assigned to the different instances in which Object 1 was identified. A first action Action 1 is shown as corresponding to F₃-F₆ and a second action Action 2 is shown as corresponding to F₁₇-F₂₁.

Application of the system 100 of FIG. 1 to the exemplary video 200 of FIG. 2 may cause different clips to be extracted from the video 200 in response to different queries. A query that searches for Object 2 may cause the search system 120 to return a clip corresponding to frames F₈-F₁₃. A query that searches for Object 1 may cause the search system 120 to return two clips corresponding to frames F₃-F₆ and F₁₇-F₂₁. A query that searches based on a classified action may cause the search system 120 to return a responsive clip (e.g., either frames F₃-F₆ if Action 1 is queried or frames F₁₇-F₂₁ if Action 2 is queried).

Exemplary applications of the system 100 are presented below.

As an example, the system 100 may be applied in a device 100 (FIG. 1) that operates as a personal media manager. For example, a device operator may capture videos of different events that occur throughout the operator's life, which may be processed to identify different people, events and/or actions represented in the videos.

In this example, search queries may be applied that search by person and action type (e.g., “dad” AND “skiing” or “cat” AND “jumping”). The search system 120 may return a response that includes clips extracted from stored videos that are tagged by metadata associated with the person and action type requested. A requestor 130 may further process the clips for presentation on the device 100 as desired. For example, the clips may be concatenated into a larger video presentation and (optionally) accompanied by an audio presentation selected by the requestor 130.

In another example, again, the system 100 may be applied in a device 100 (FIG. 1) that operates as a personal media manager. The storage device 114 may store videos captured by a device operator throughout the operator's life, which may be processed to identify different people, events and/or actions represented in the videos. In this example, occurrences of people and/or actions may have durations assigned to them representing the amounts of time that the people and/or actions occur within the video content.

In this example, search queries may be applied that search by person and a desired duration (e.g., “dad” AND 25 seconds). The search system 120 may return a response that includes clips extracted from stored videos that are tagged by metadata associated with the person and meet the desired duration parameter within a tolerance threshold. A requestor 130 may further process the clips for presentation on the device 100, as desired.

This example may find application where extracted clips are to be concatenated into a larger video presentation and time-aligned with an audio presentation selected by the requestor 130. The audio presentation may have different temporal intervals of significance (example: a song in which verses last for 45 seconds, choruses last for 25 seconds, etc.). The requestor 130 may issue queries for desired content that identify the durations of the audio intervals to which clips are to be aligned. When responsive clips are provided by the search system 120, the requestor 130 may compile a concatenated video by aligning, with the verses, the clips whose durations coincide with the verses' duration and by aligning, with the choruses, the clips whose durations coincided with the choruses' duration.

In yet another example, again, the system 100 may be applied in a device 100 (FIG. 1) that operates as a personal media manager. The storage device 114 may store videos captured by a device operator throughout the operator's life, which may be processed to identify different people, events and/or actions represented in the videos. In this example, occurrences of people, events and/or actions may have durations assigned to them representing the amounts of time that the people and/or actions occur within the video content. Videos also may have motion flow estimates developed and applied to them that identify magnitudes of motion detected within videos.

In this example, search queries may be applied that search by event, a desired duration and a classification of motion flow (e.g., “wedding”+25 seconds+highly active). The search system 120 may return a response that includes clips extracted from stored videos that are tagged by metadata classifying the video as a wedding, the desired duration within a tolerance threshold, and the requested level of motion flow. A requestor 130 may further process the clips for presentation on the device 100, as desired.

This example may find application where extracted clips are to be concatenated into a larger video presentation and time-aligned with an audio presentation having different properties. Again, the audio presentation may have different temporal intervals of significance (example: verses that last for 45 seconds, choruses that last for 25 seconds, etc.) and different levels of activity associated with it (e.g., high tempo vs. low tempo). The requestor 130 may issue queries for desired content that identify desired motion flow and the durations of the audio intervals to which clips are to be aligned. When responsive clips are provided by the search system 120, the requestor 130 may compile a concatenated video by, for example, aligning high motion flow clips with portions of audio classified as high tempo and aligning low motion flow clips with portions of audio classified as low tempo.

In a further example, the system 100 may be applied in a device 100 (FIG. 1) that operates with a video editing system. The storage device 114 may store raw videos captured during filming of scenes for video production. The videos may be stored with metadata that tags the videos according to actors that appear in the content, objects identifying set locations that appear in the video content, voice overs converted to text that identify by number and take the scenes being filmed, and other indicia of production content.

In this example, search queries may identify desired clips by the scenes, actors and locations as represented in another data file. For example, a storyboard data file may identify a progression of scenes and actors that are to appear in a produced video. Queries may be received by the search system 120 that identify desired clips by scene and/or actor, which may be furnished in response. A requestor 130 may assemble an editable video from the clips so extracted that match the progression of scenes as represented in the storyboard file. The editable video may be presented to editing personnel for review and assembly.

The foregoing examples are just that, examples. In use, it is anticipated that far more complex queries may be presented to the system 100 that include any combination of metadata generated by the analytics unit 112 that indexes the videos in storage 114. Queries further may contain parameters that identify, for example, desired playback properties of video such as playback window size, orientation (e.g., landscape or portrait orientation), playback speed, and/or whether video is looped; compositional elements of desired video as scene type, camera motion type and magnitude, human action type, action magnitude, object motion pattern, the number of people or pets recognized in video, and/or the sizes of people or pets represented in video; and/or directed user interaction properties, such as videos tagged with specific person/pet identifiers, user-liked videos, user-edited video, user preferred styles, and the like. The multi-dimensional analytics unit 112 provides a wide array of search indicia that can be applied in search queries.

As discussed, the search system 120 (FIG. 1) may return search results that contain clips that are the closest match to parameters provided in a search query. For multi-dimensional queries, the search results may contain metadata that identifies, on a parameter by parameter basis, a match score. The multi-dimensional match score may be used by a requestor 130 to prioritize among responsive clips when processing them.

In one embodiment, the search service 120 may provide all responsive clips in search results. In another embodiment, the search service 120 may provide a capped number of clips according to the clips' respective matching scores. In a further embodiment, the search service 120 may provide search results that summarize different scenes detected in responsive videos.

In a further embodiment, search results may include suggested playback properties that a requestor 130 may use when processing responsive clips. For example, search results may identify spatial sizes of detected people, animals or objects with clips, which may be used as cropping values (either a fixed crop window or a moving window) during clip processing. Alternatively, search results may include playback zoom factors, stabilization parameters, slow-motion ramping values and the like, which a requestor 130 may use when rendering clips or integrating them into other media presentations.

Search results further may identify content properties such as scene types, camera motion types, camera orientation, frame quality scores, people/animal identifiers, and the like, which a requestor may integrated into its processing decisions.

In another embodiment, the system 100 (FIG. 1) may be used to retrieve explicitly identified videos from storage. In this embodiment, rather than provide a video in its entirety, a responsive clip may be formed from portions of the video that are identified as containing recognized content elements (e.g., a first portion that contains a recognized person, a second portion that contains a recognized animal, etc.).

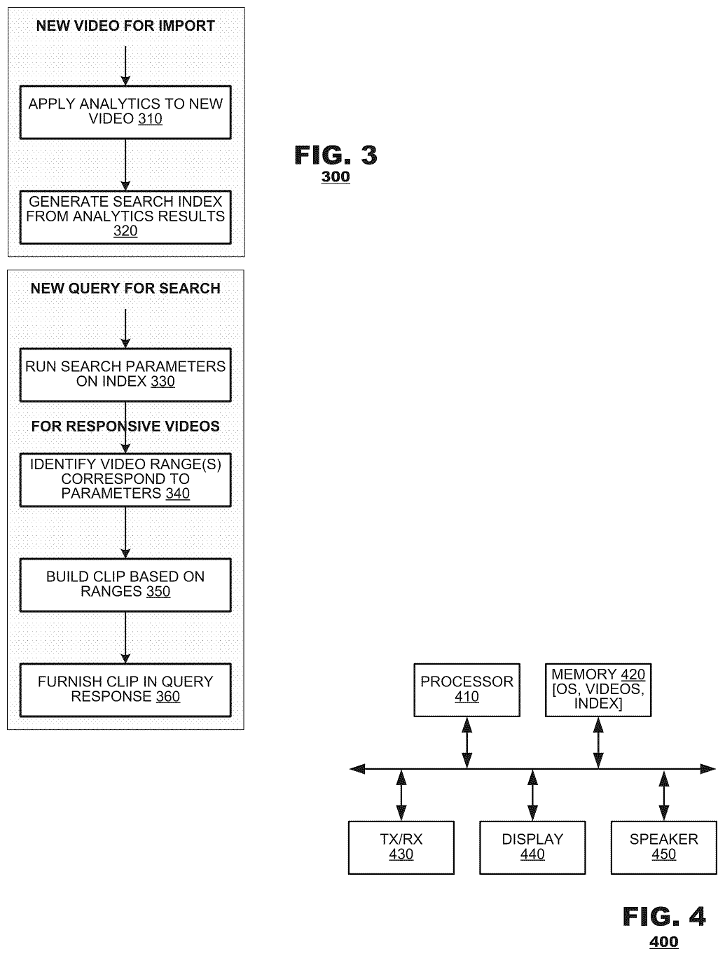

FIG. 3 illustrates a method 300 according to an embodiment of the present disclosure. As illustrated, the method 300 may operate in two major phases, when a new video is presented for importation into the system 100 (FIG. 1) and when the system 100 fields a new query. These two phases may and typically will operate asynchronously in multiple iterations over the lifecycle of the system 100.

In an embodiment, when a new video is presented for importation, the method 300 may apply analytics to the new video (box 310) as discussed above. As discussed, the analytics may generate metadata results for the new video, from which the method 300 may build a search index (box 320) as the video is stored.

In an embodiment, when a query is presented, the method 300 may run a search on the index utilizing search parameters provided in the query (box 330). For responsive videos, the method 300 may determine range(s) within the video that correspond to the search parameters (box 340). The method 300 may build clips from the responsive videos based on the ranges (box 350) and furnish the clips to a requestor in a query response (box 360).

FIG. 4 is a block diagram of a device 400 according to an aspect of the present disclosure. The device 400 may find application as the system 100 of FIG. 1. The device 400 may include a processor 410 and a memory 420. The memory 420 may store program instructions that define an operating system and various applications that are executed by the processor 410, including, for example, the analytics unit 112 and a search system 120. The memory 420 also may function as storage 114 (FIG. 1) storing videos and an index of metadata generated by the analytics unit 112. The memory 420 may include a computer-readable storage media such as electrical, magnetic, or optical storage devices.

The device 400 may possess a transceiver system 430 to communicate with other system components, for example, requestors 130 (FIG. 1) in certain embodiments that are provided on separate devices. The transceiver system 430 may communicate with requestors over a wide variety of wired or wireless electronic communications networks.

The device also may include display(s) and/or speaker(s) 440, 450 to render video retrieved from storage 114 according to the techniques described in the examples hereinabove.

Although the system 100 (FIG. 1) is illustrated as embodied in a smartphone, the principles of the present disclosure are not so limited. The principles of the present disclosure find application with a variety of electronic devices such as personal computers, laptop computers, tablet computers, media servers, gaming systems, digital picture frames, and the like.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure. The present specification describes components and functions that may be implemented in particular embodiments, which may operate in accordance with one or more particular standards and protocols. However, the disclosure is not limited to such standards and protocols. Such standards periodically may be superseded by faster or more efficient equivalents having essentially the same functions. Accordingly, replacement standards and protocols having the same or similar functions are considered equivalents thereof.

We claim:

1. A media search method, comprising:
responsive to a query identifying desired parameters of media, searching an index of stored videos for videos responsive to the query,
retrieving at least one video from storage that is responsive to the query,
creating a clip extracted from the retrieved video based on the query parameters and an identification of a portion of the video to which the query parameters apply, and
providing the clip in a query response.

2. The method of claim 1, wherein:
the index identifies predetermined object(s) detected in the stored videos and durations representing range(s) of the stored video in which the respective object is detected, and
the clip contains a portion of the stored video for which a specified object appears in the video as reflected by the respective duration.

3. The method of claim 2, wherein the predetermined object(s) include people identifiers.

4. The method of claim 2, wherein the predetermined object(s) include animal identifiers.

5. The method of claim 2, wherein the predetermined object(s) include object type identifiers.

6. The method of claim 1, wherein:
the index identifies predetermined object action(s) detected in the stored videos and durations representing range(s) of the stored video in which the respective object action is detected, and
the clip contains a portion of the stored video for which a specified object action appears in the video as reflected by the respective duration.

7. The method of claim 1, wherein:
the index stores duration values representing ranges of the stored video in which the respective objects are detected, and
when the query specifies a desired duration, the searching searches for correspondence between the desired duration and the stored duration values.

8. The method of claim 1, wherein:
the index stores motion flow values representing motion activity detected in stored video, and
when the query specifies a motion classification, the searching searches for correspondence between the motion classification and the motion flow values.

9. The method of claim 1 further comprising concatenating a plurality of clips from the query response into presentation.

10. The method of claim 9, wherein the concatenating comprises aligning the clips in the aggregate media item with an audio asset of the media item according to the clips' durations.

11. The method of claim 9, wherein the concatenating comprises aligning the clips in to a storyboard file from a video editing system.

12. The method of claim 1, wherein:
the index identifies predetermined speaker(s) detected from audio associated with the stored videos and durations representing range(s) of the stored video in which the respective speakers are detected as speaking, and
the clip contains a portion of the stored video for which a specified speaker is associated with the video as reflected by the respective duration.

13. The method of claim 1 wherein:
the index stores text associated with stored video, and
when the query specifies a text parameter, the searching searches for correspondence between the text parameter and stored text in the index.

14. The method of claim 1 wherein, when the search identifies a plurality of videos that are responsive to the query:
generating comparative scores of the videos based on a predetermined metric, and
ranking the videos according to the metric;
wherein the creating creates the clips from videos selected by a requestor.

15. The method of claim 14 wherein the metric is a size of a specified object within a responsive portion of video.

16. The method of claim 14 wherein the metric is a motion characteristic of a specified object in video.

17. The method of claim 14 wherein the metric is a scene classification.

18. The method of claim 14 wherein the metric identifies camera stability within a responsive portion of video.

19. A media system, comprising:
a storage device for storing media assets and associated metadata;
a content analysis system that assigns metadata to portions of media assets based on object detection performed upon the media assets; and
a metadata index identifying object(s) detected within the media assets and duration(s) representing range(s) of the respective media asset(s) in which such objects are detected.

20. The media system of claim 19, wherein the content analysis system is a trained machine learning system.

21. The media system of claim 19, wherein the predetermined object(s) include people identifiers.

22. The media system of claim 19, wherein the predetermined object(s) include animal identifiers.

23. The media system of claim 19, wherein the predetermined object(s) include object type identifiers.

24. The media system of claim 19, wherein the index identifies predetermined object action(s) detected in the media assets and durations representing range(s) of the respective media asset in which the object action is detected.

25. The media system of claim 19, wherein the index stores motion flow values representing motion activity detected in stored video, and durations representing range(s) of the respective media asset in which the motion flow is detected.

26. The media system of claim 19, wherein the index identifies predetermined speaker(s) detected from audio associated with the stored videos and durations representing range(s) of the stored video in which the respective speakers are detected as speaking.

27. The media system of claim 19, wherein the index stores text associated with stored video, and durations representing range(s) of the stored video to which the respective text relates.

28. The media system of claim 19, wherein the metadata identifies a size of a specified object within a respective portion of the media asset.

29. The media system of claim 19, wherein the metadata identifies a scene classification.

30. The media system of claim 19, wherein the metadata identifies a camera stability factor within a responsive portion of video.

31. The media system of claim 19, further comprising a clip retrieval system that retrieves portion(s) of stored media assets in response to requestor queries, the portions retrieved based on correspondence between query search terms, index identifiers for the media assets, and duration identifiers identifying temporal location(s) of video associated with the identifiers.

32. The media system of claim 31, wherein search results of the clip retrieval system are concatenated together.

33. The media system of claim 31, search results of the clip retrieval system are ranked according to comparative scores of the videos based on a predetermined metric.

34. A non-transitory computer readable medium storing program instructions that, when executed by a processor, cause the processor to:
respond to a query identifying desired parameters of media by searching an index of stored videos for videos responsive to the query,
retrieve at least one video from storage that is responsive to the query,
create a clip extracted from the retrieved video based on the query parameters and an identification of a portion of the video to which the query parameters apply, and
provide the clip in a query response.

35. The computer readable medium of claim 34, wherein:
the index identifies predetermined object(s) detected in the stored videos and durations representing range(s) of the stored video in which the respective object is detected, and
the clip contains a portion of the stored video for which a specified object appears in the video as reflected by the respective duration.

36. The computer readable medium of claim 34, wherein:
the index identifies predetermined object action(s) detected in the stored videos and durations representing range(s) of the stored video in which the respective object action is detected, and
the clip contains a portion of the stored video for which a specified object action appears in the video as reflected by the respective duration.

37. The computer readable medium of claim 34, wherein:
the index stores duration values representing ranges of the stored video in which the respective objects are detected, and
when the query specifies a desired duration, the searching searches for correspondence between the desired duration and the stored duration values.

38. The computer readable medium of claim 34, wherein:
the index stores motion flow values representing motion activity detected in stored video, and
when the query specifies a motion classification, the searching searches for correspondence between the motion classification and the motion flow values.

39. The computer readable medium of claim 34, wherein the program instructions further cause the processor to concatenate a plurality of clips from the query response into presentation.

40. The computer readable medium of claim 34, wherein:
the index identifies predetermined speaker(s) detected from audio associated with the stored videos and durations representing range(s) of the stored video in which the respective speakers are detected as speaking, and
the clip contains a portion of the stored video for which a specified speaker is associated with the video as reflected by the respective duration.

41. The computer readable medium of claim 34, wherein:
the index stores text associated with stored video, and
when the query specifies a text parameter, the searching searches for correspondence between the text parameter and stored text in the index.
